(19) United States
(12) Patent Application Publication
(10) Pub. No.: US 2024/0174109 A1
(43) Pub. Date: May 30, 2024

(54) CHARGING STATION FOR ELECTRICALLY POWERED MOTOR VEHICLES AND METHOD TO OPERATE SUCH A CHARGING STATION

(71) Applicant: ads-tec Energy GmbH, Nürtingen (DE)

(72) Inventors: Johannes SCHUCHTER, Grasbrunn (DE); Andreas GREIF, Weilheim (DE); Roman MOLCHANOV, Neckartenzlingen (DE)

(21) Appl. No.: 18/511,189

(22) Filed: Nov. 16, 2023

(30) Foreign Application Priority Data
Nov. 24, 2022 (DE) 102022131173.2

(51) Int. Cl. B60L 53/60; G06T 7/70; G06V 20/52; G06V 20/62; G06V 40/10; G06V 40/20

(52) U.S. Cl. CPC B60L 53/60; G06T 7/70; G06V 20/52; G06V 20/625; G06V 40/10; G06V 40/20; G06T 2207/30196; G06T 2207/30232; G06T 2207/30242; G06T 2207/30252; G06V 2201/08

(57) ABSTRACT

The invention relates to a charging station for electrically powered motor vehicles, whereby the charging station is configured to detect at least one signal and to initialize at least one action as a function of the at least one detected signal.

### CROSS REFERENCE TO RELATED APPLICATIONS

This application claims priority to and the benefit of German Patent Application No. 102022131173.2 filed on Nov. 24, 2022, the entire contents of which are incorporated herein by reference.

The invention relates to a charging station for electrically powered motor vehicles and a method for operating such a charging station.

In connection with the operation of a charging station for electrically powered motor vehicles, a plurality of situations are created, in which a proactive and/or quickly initialized action is desirable, in order to, for example, accelerate the charging process for a user, to make it more comfortable, to design the surrounding area of the charging station to be more pleasant and/or safer, or also to generate an additional use for the operator of the charging station. Beyond the basic functionality of the charging of vehicles, however, conventional charging stations do not have any additional functions. They in particular do not have any information about charging processes, which can be expected in the near future, and can thus not be suitably conditioned ahead of a charging process. This partially delays the charging process significantly, in particular in the case of particularly hot or cold outside temperatures.

The invention is thus based on the object of creating a charging station for electrically powered motor vehicles and a method for operating such a charging station, whereby the mentioned disadvantages are at least reduced, preferably avoided.

The object is solved in that the present technical teaching is provided, in particular the teaching of the independent claims as well as of the embodiments disclosed in the dependent claims and the description.

The object is solved in particular in that a charging station for electrically powered motor vehicles is created, which is configured to detect at least one signal and to initialize at least one action as a function of the detected at least one signal. Advantageously, the charging station is quasi trained in this way to perceive information about its surrounding area and/or the near future and to appropriately react thereto. This in particular allows for an acceleration and/or more comfortable design of charging processes, the provision of a more pleasant and/or safer surrounding area for the user, or also a generation of additional uses for the operator of the charging station.

In electrical engineering, any, in particular stationary or mobile device or electrical installation, which serves the purpose of supplying energy to mobile accumulator-operated equipment, machines, or motor vehicles, by means of a simple setting or plugging in, without inevitably having to remove the energy storage—for instance the traction battery of an electric vehicle—is referred to as charging station. Charging stations for electric vehicles are sometimes also referred to as “electricity charging stations” and can comprise several charging points. In particular direct current quick charging systems (high performance charging systems or high power charging systems, HPC systems) such as the so-called combined charging system (CCS), which is common in Europe, are known here. During the generic direct current charging, direct current from the charging station is fed directly into the battery of the vehicle and is, for this purpose, provided to, e.g., solar charging stations by means of a powerful rectifier, preferably of the charging station, from the power supply or by means of large buffer accumulators. A battery management system, which communicates directly or indirectly with the charging station, in order to adapt the current and voltage or to end the process when reaching a predetermined capacity limit, is located in the vehicle. Power electronics are thereby typically located in the charging station. Due to the fact that the DC connections of the charging station are connected directly—without detour via an AC/DC converter of the vehicle—to corresponding terminals of the traction battery, high charging currents can be transferred with little loss, which provides for short charging times.

In one embodiment, the charging station is formed as a charging column. The charging station in particular has at least one charging point, in particular exactly one charging point or exactly two charging points.

The charging station is in particular formed as quick charging station. In one embodiment, the charging station is formed as battery-supported charging station, in particular as battery-supported quick charging station.

In the context of the present technical teaching, at least one signal is in particular understood to be an additional signal, which is detected in addition to a direct interaction of the charging station with a user as well as signals, which are assigned to a motor vehicle to be charged, as part of the charging or payment process. A signal is furthermore in particular understood to be any type of information—in particular independently of the embodiment of the signal—which can be processed automatically, in particular by a control device of the charging station. A signal is in particular understood to be a data stream, in particular independently of a type, a content, or a format of the data stream.

According to a further development of the invention, it is provided that the charging station has at least one detection device, which is configured to detect the at least one signal.

The charging station in particular has the at least one detection device in addition to a user interface, which serves the purpose of the direct interaction of the charging station with a user as part of the charging or payment process.

In one embodiment, the at least one detection device is selected from a group, consisting of: A communication module, in particular configured to communicate via a data network, and a camera.

Advantageously, these are particularly suitable detection devices, in particular with regard to the realization of the advantages, which have already been mentioned above.

If the at least one detection device is a communication module, information can be received therewith—in particular via a data network—and can be used to realize in particular the above-mentioned advantages. The data network can be, for example, the Internet, a local network, a satellite communication network, a mobile radio network, or another network.

If the at least one detection device is a camera, information about the immediate surrounding area of the charging station can be obtained easily and quickly therewith—in particular by means of image evaluation of images recorded by the camera—and can be used to realize in particular the above-mentioned advantages. The camera is in particular configured to record static individual images and/or to record a temporal image stream, in particular a video.

In one embodiment, the charging station has a communication module as a first detection device as well as a camera as a second detection device. The charging station can also have a plurality of communication modules and/or a plurality of cameras, in particular in order to cover several communication paths and/or a larger surrounding area region.

In one embodiment, the at least one detection device is configured to evaluate the at least one signal. Advantageously, the evaluation of the signal can then take place directly in the detection device in a simple and cost-efficient manner. It is possible in particular that the at least one detection device is additionally configured to initialize the at least one action as a function of the at least one signal. Advantageously, an additional device is then also not required for this purpose.

According to a further development of the invention, it is provided that the charging station has a control device, which is operatively connected to the at least one detection device and which is configured to initialize the at least one action as a function of the at least one signal detected by the detection device. Advantageously, an in particular high-performance device can be provided in this way in order to optionally evaluate the signal and to start the at least one action.

In one embodiment, the at least one detection device is configured to evaluate the at least one signal, whereby the control device is configured to receive the evaluated signal and to initialize the at least one action as a function of the evaluated signal. Alternatively, the control device is configured to evaluate the at least one signal received from the detection device—in particular as raw signal—and to initialize the at least one action as a function of the evaluated signal. Alternatively, it is possible that the evaluation of the at least one signal is divided between the detection device on the one hand and the control device on the other hand, whereby the detection device is configured to carry out at least a first substep for evaluating the at least one signal, whereby the control device is configured to receive the partially evaluated signal from the detection device and to carry out at least one second substep for evaluating the at least one signal. The control device is in particular configured to initialize the at least one action as a function of the evaluated signal.

According to a further development of the invention, it is provided that the at least one action is selected from a group, consisting of: Changing an operating state of the charging station, in particular switching over the charging station from a rest state into an active state, controlling the temperature of, in particular climate controlling, the charging station, setting a climate control parameter of the charging station, displaying a predetermined content on a display device of the charging station, sending a message or a transmission signal, activating a lighting device of the charging station, changing a brightness of a lighting device or of a display device of the charging station, modifying the type and/or frequency of a content displayed on a display device of the charging station, communicating with at least one other charging station, opening a communication channel, and establishing a communication connection.

A temperature conditioning or climate control of the charging station is in particular understood to be the controlling of the temperature or climate control of a cooling liquid, in particular of a cooling tank, of the charging station.

The charging station is in particular switched from a rest state or standby state into an active state when it is recognized on the basis of the at least one signal that a charging process can be expected in the near future. Advantageously, the actual charging process can be accelerated thereby. Advantageously, an in particular acoustic negative impacting of a surrounding area of the charging station can furthermore be reduced when the charging station is switched into the active state only when a charging process is in fact expected.

The temperature of the charging station is in particular controlled, it is in particular air conditioned, when it is recognized on the basis of the at least one signal that a charging process can be expected in the near future. Charging can thereby advantageously be performed from the beginning with a higher electrical power thereby.

A climate control parameter of the charging station, in particular a temperature to which the temperature of the charging station is controlled, or a climate control power is in particular set as a function of the at least one signal, in particular when a conclusion is drawn to a type or characteristic of a vehicle, which is to be charged in the near future, in particular to an expected or maximum charging power of the vehicle due to the at least one signal. The charging process can thus be accelerated on the one hand, the conditioning of the charging station can take place particularly energy-efficiently on the other hand, in particular because an excessive climate control does not take place.

The content displayed on the display device is in particular adapted to the at least one signal, whereby the at least one signal can in particular represent a type or characteristic of a user of the charging station or a situation, which currently prevails in the surrounding area of the charging station. The displayed content can thus advantageously be selected so as to match the user and/or the situation.

Technical, police and/or medical assistance is in particular called by sending a message or a transmission signal as a function of the at least one signal.

Advantageously, the charging station in particular draws the attention of a potential user by activating the lighting device and can thus guide said user to the charging station, when it is recognized on the basis of the at least one signal that a user, who is ready to charge, approaches. The activation of the lighting device can in particular comprise the setting or changing of a color of the light emitted by the lighting device, for example also time-varying colors, in particular play of colors or the like. The lighting device can be integrated into the charging station discretely, for example into ventilation slots of the charging station.

The charging station can in particular draw attention, guide a potential user towards it, or can contribute to a brighter surrounding area illumination and thus to a safer surrounding area by changing a brightness of a lighting device of a display device of the charging station, in particular also by activating the display device, which is initially dark, when it is recognized on the basis of the at least one signal that a user, who is ready to charge, approaches.

The charging station can in particular react to a frequenting of the surrounding area of the charging station, which is recognized on the basis of the at least one signal, that is, in particular to a temporal number density as well as preferably to characteristics of persons staying in the surrounding area of the charging station, by modifying the type and/or frequency of a content displayed on a display device of the charging station, and can thus display adapted contents and/or can save energy in connection with the display of contents.

The charging station in particular communicates with at least one other, in particular adjacent, charging station when it is recognized on the basis of the at least one signal that a motor vehicle comprising a battery is to be charged, the capacity of which exceeds a predetermined capacity threshold value and/or the charging state of which falls below a predetermined charging state threshold value. The charging stations then in particular exchange information with one another about their respective state, in particular their currently available charging power and/or a buffer battery charging state; the charging stations in particular negotiate with one another, which charging station is more suitable for charging the motor vehicle, in particular which charging station can charge the motor vehicle more quickly. At least one of the charging stations subsequently emits a pilot signal, in order to guide the motor vehicle to the charging station, which is more suitable. The pilot signal can be an electronic pilot signal, a light pilot signal, a pilot signal displayed on the display device, or any other suitable pilot signal.

The charging station in particular opens a communication channel—in particular to a technical service—when it is recognized on the basis of the at least one signal that a user has technical problems when charging his vehicle. In particular a telephone or video conference connection to a technical service can be established.

The charging station in particular establishes a communication connection to a terminal of a user or to a communication module of a motor vehicle when a demand for this is recognized on the basis of the at least one signal. The user or the motor vehicle can then in particular upload contents from the terminal or the communication module to the charging station, in particular for example stream movies or videos to the display device of the charging station. For example, a larger display for watching such contents is thus advantageously available to the user, than if he watches them on his mobile terminal or in his motor vehicle.

According to a further development of the invention, it is provided that the at least one detection device is formed as camera, whereby the charging station, in particular the control device, is configured to inspect images recorded by the camera with regard to at least one inspection feature and to initialize the at least one action as a function of the at least one inspection feature. Advantageously, an action adapted to processes taking place in the surrounding area of the charging station can in particular be initialized in this way.

The recorded image are thereby in particular the at least one signal. Alternatively or additionally, the at least one inspection feature or the presence or absence of the inspection feature in an image is the at least one signal.

The charging station, in particular the detection device itself or the control device, is in particular configured to process images recorded by the detection device, in particular to carry out an image recognition or to recognize predetermined features in the recorded images. A classical image recognition algorithm or a suitably trained artificial intelligence, in particular based on machine learning, is in particular used for this purpose.

In one embodiment, the at least one inspection feature is selected from a group, consisting of: A motor vehicle approaching the charging station, a ready-to-charge behavior of a passenger of a motor vehicle in the region of the charging station, a vehicle characteristic, in particular vehicle type or vehicle model of a motor vehicle approaching the charging station, a license plate of a motor vehicle approaching the charging station, at least one characteristic of a passenger of a motor vehicle in the region of the charging station, a number or type of passengers of a motor vehicle—and/or canine companions of said passengers, for example dogs—in the region of the charging station, a behavior of a person or of another living being staying in the region of the charging station, a number of persons staying in the region of the charging station, a frequenting of the region of the charging station by persons or motor vehicles, and encoded information, in particular a QR code.

The charging station is in particular switched from a rest state or standby state into an active state when it is recognized that a motor vehicle approaches the charging station or when a ready-to-charge behavior of a passenger of a motor vehicle is recognized in the region of the charging station.

The temperature of the charging station is in particular controlled, it is in particular air conditioned, when it is recognized that a motor vehicle approaches the charging station or if a ready-to-charge behavior of a passenger of a motor vehicle is recognized in the region of the charging station.

Alternatively or additionally, the charging station draws attention, advantageously by activating the lighting device when it is recognized that a motor vehicle approaches the charging station or when a ready-to-charge behavior of a passenger of a motor vehicle is recognized in the region of the charging station.

Alternatively or additionally, the charging station draws attention by changing the brightness of the lighting device or of the display device, and/or it guides a potential user closer towards it, and/or it contributes to a brighter surrounding area illumination and thus to a safer surrounding area, when it is recognized that a motor vehicle approaches the charging station or when a ready-to-charge behavior of a passenger of a motor vehicle is recognized in the region of the charging station.

A climate control parameter of the charging station, in particular a temperature to which the temperature of the charging station is controlled, or a climate control power is in particular selected as a function of a vehicle characteristic, in particular a vehicle type or vehicle model of a motor vehicle approaching the charging station, in particular as a function of an expected or maximum charging power of the vehicle.

On the basis of an in particular specific or vehicle-specific vehicle characteristic, in particular of a license plate of a motor vehicle approaching the charging station, it can in particular be verified whether the approaching motor vehicle corresponds to a motor vehicle, from which a charging request had previously been sent to the charging station—in particular via a data network. The charging station can then in particular block the charging process for other motor vehicles and can release it only for that motor vehicle, for which the charging request had been received previously. Advantageously, a reservation of the charging station is already possible in this way on the way to the charging station.

The content displayed on the display device is in particular adapted to at least one characteristic or a number or type of passengers of a motor vehicle in the region of the charging station—and/or to their canine companions, for example dogs.

The charging station in particular communicates with at least one other charging station in order to negotiate which of the charging stations is more suitable for charging the approaching motor vehicle. A conclusion can in particular be drawn to a capacity of a battery installed in the motor vehicle on the basis of the vehicle characteristic.

Technical, police and/or medical assistance is in particular called by sending a message or a transmission signal as a function of the behavior of a person or of another living being staying in the region of the charging station. Alternatively or additionally, the charging station opens a communication channel—in particular to a technical service—when a need for this is recognized on the basis of the behavior of the persons or of another living being staying in the region of the charging station.

The charging station in particular modifies the type and/or frequency of a content displayed on a display device of the charging station as a function of the number of the persons staying in the region of the charging station and/or of a frequenting of the region of the charging station by persons or motor vehicles.

The charging station in particular establishes a communication connection to a terminal of a user or to a communication module of a motor vehicle when correspondingly suitable encoded information, in particular a QR code is recognized.

According to a further development of the invention, it is provided that the at least one detection device is formed as communication module, which is configured to receive a receive signal or a message in particular from a data network as the at least one signal.

A message, with which a user sends a charging request to the charging station, is in particular received by the communication module. Such a message can in particular be generated via an—in particular mobile—application, in particular an app. A user can in particular reserve the charging station for himself in this way. To verify the reservation, the user can transmit an in particular specific vehicle characteristic, for example the license plate, the manufacturer, the model, or another identification feature of his motor vehicle, to the charging station. The charging station can then preferably verify the motor vehicle approaching the charging station on the basis of the transmitted identification feature, in particular of the license plate, and can in particular release the charging process for the motor vehicle, for which the change request had been received previously, but can block the charging process for other motor vehicles.

The receive signal or the message can in particular also comprise information about the charging state of a motor vehicle to be charged. A charging station, which is most suitable for charging the motor vehicle, can then be negotiated as a function of the charging state in particular by communication between a plurality of charging stations.

According to a further development of the invention, it is provided that the charging station, in particular the control device, is configured to additionally initialize the at least one action as a function of at least one surrounding area parameter of the charging station. Advantageously, further parameters can be used for the operation of the charging station in this way.

In one embodiment, the at least one surrounding area parameter is selected from a group, consisting of: A location of the charging station and a current time of day. Advantageously, in particular concerns from facilities or persons adjacent to the charging station, in particular residents, can be considered in this way, in particular with regard to a noise development during temperature conditioning or climate control of the charging station. With regard to the noise development, which is to be tolerated, it is relevant, for example, whether the charging station is set up in a residential area or on a highway, in particular on a highway rest stop.

Alternatively or additionally, a surrounding area temperature of the charging station can be used as the at least one surrounding area parameter. The surrounding area temperature can in particular be considered for temperature conditioning or climate control of the charging station, in particular in order to carry this out as energy-efficiently as possible.

According to a further development of the invention, it is provided that the charging station, in particular the control device, is configured to verify whether a motor vehicle approaches the charging station on the basis of camera images from the detection device, which is formed as camera, and to precondition the charging station when a motor vehicle approaches the charging station.

Preconditioning is thereby in particular understood such that the charging station is shifted from a rest state into an active state and/or the temperature thereof is controlled or it is air conditioned.

In particular, the charging station, in particular the control device, is configured to recognize a vehicle characteristic, in particular a vehicle type, a manufacturer and/or a model of a motor vehicle approaching the charging station on the basis of the camera images, and to select at least one conditioning parameter for the preconditioning, in particular the climate control parameter, as a function of the vehicle characteristic.

According to a further development of the invention, it is provided that the charging station, in particular the control device, is configured to recognize an activity in the region of the charging station on the basis of camera images of the detection device, which is formed as camera, and to send out an activity-related message and/or to open a communication channel on the basis of the recognized activity.

A communication channel is opened in order to provide technical aid, in particular in the form of a voice and/or video communication connection (video chat), in particular when an operating error or a technical problem in the operation of the charging station is recognized as the activity.

A message is sent to an emergency response center or to an emergency service and help is called in particular, particular when a health-related or medical problem of a person in the surrounding area of the charging station is recognized as the activity.

A message is sent to a police station or a security service in particular when an unlawful or aggressive action against the charging station itself or against persons in the surrounding area of the charging station, or a criminal offense, or vandalism, or the like is recognized as the activity.

Alternatively or additionally, a message is displayed on the display device of the charging station, by means of which persons in the surrounding area of the charging station are informed that they are under surveillance, in particular are photographed or filmed. In addition, the recognized activity is preferably recorded permanently by means of the camera in order to preserve evidence and/or is transmitted—in particular via a data network—to the police station or the security service in order to preserve evidence.

According to a further development of the invention, it is provided that the charging station, in particular the control device, is configured to detect encoded information on the basis of camera images of the detection device, which is formed as camera, and to establish a communication connection as a function of the encoded information.

In particular when encoded information, which is suitable for establishing a data-transferring connection, for example a QR code displayed on a smartphone or another terminal, is recognized, a streaming connection is established, via which the user can stream contents, in particular movies, to the display device of the charging station, from the in particular mobile terminal or his motor vehicle.

The object is also solved in that a method for operating a charging station, in particular a charging station according to the invention or a charging station according to one or several of the above-described embodiments is created, whereby at least one signal is detected by the charging station—in particular automatically—and at least one action is initialized by the charging station as a function of the detected at least one signal—in particular automatically. In particular those advantages, which have already been described in connection with the charging station, result in connection with the method.

The method in particular comprises at least one step, preferably a combination of steps, which have already been described explicitly or implicitly above in connection with the charging station.

The charging station, in particular the control device, is accordingly configured in particular to carry out at least one step, preferably a combination of steps, which have already been described explicitly or implicitly above in connection with the charging station.

The invention will be described in more detail below on the basis of the drawing, in which the sole

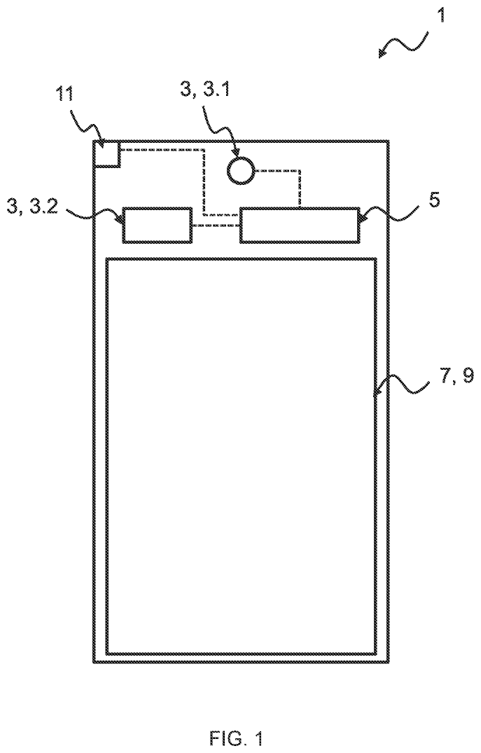

FIG. 1 shows a schematic illustration of an exemplary embodiment of a charging station for electrically powered vehicles.

The sole FIGURE shows a schematic illustration of an exemplary embodiment of a charging station 1 for electrically powered vehicles.

The charging station 1 is configured to detect at least one signal and to initialize at least one action as a function of the detected at least one signal.

The charging station 1 in particular has at least one detection device 3, which is configured to detect the at least one signal. In the case of the exemplary embodiment illustrated here, the charging station 1 has two detection devices 3, namely a first detection device 3, which is formed as camera 3.1, and a second detection device 3, which is formed as communication module 3.2. In particular, information can be received—in particular via a data network—by means of the communication module 3.2.

In addition, the charging station 1 in particular has a control device 5, which is operatively connected to the camera 3.1 and the communication module 3.2 and which is configured to initialize the at least one action as a function of the at least one signal detected by the respective detection device 3.

The at least one action is in particular selected from a group, consisting of: Changing an operating state of the charging station 1, in particular switching the charging station 1 from a rest state into an active state, conditioning the temperature of, in particular controlling the climate of the charging station 1, setting a climate control parameter of the charging station 1, displaying a predetermined content on a display device 7 of the charging station 1, in particular a display 9, sending a message or a transmission signal, activating a lighting device 11 of the charging station 1, changing a brightness of a lighting device 11 or of the display device 7, modifying the type and/or frequency of a content displayed on a display device 7, communicating with at least one other charging station, opening a communication channel, and establishing a communication connection.

The charging station 1 is in particular configured to carry out a method described in more detail below. The control device 5 is in particular configured to carry out the method.

Images recorded by the camera 3.1 as part of the method are in particular inspected with regard to at least one inspection feature, and the at least one action is initialized as a function of the at least one inspection feature.

The at least one inspection feature is in particular selected from a group, consisting of: A motor vehicle approaching the charging station 1, a ready-to-charge behavior of a passenger of a motor vehicle in the region of the charging station 1, a vehicle characteristic, in particular a vehicle type or vehicle model of a motor vehicle approaching the charging station 1, a license plate of a motor vehicle approaching the charging station, at least one characteristic of a passenger of a motor vehicle in the region of the charging station 1, a number or type of passengers of a motor vehicle in the region of the charging station 1, a behavior of a person or of another living being staying in the region of the charging station 1, a number of persons staying in the region of the charging station 1, a frequenting of the region of the charging station 1 by persons or motor vehicles, and encoded information, in particular a QR code.

The charging station 1 is in particular switched from a rest state or standby state into an active state when it is recognized that a motor vehicle approaches the charging station 1 or when a ready-to-charge behavior of a passenger of a motor vehicle is recognized in the region of the charging station 1.

The temperature of the charging station 1 is in particular controlled, it is in particular air conditioned, when it is recognized that a motor vehicle approaches the charging station 1, or when a ready-to-charge behavior of a passenger of a motor vehicle is recognized in the region of the charging station 1.

Alternatively or additionally, the charging station 1 advantageously draws attention by activating the lighting device 11 when it is recognized that a motor vehicle approaches the charging station 1 or when a read-to-charge behavior of a passenger of a motor vehicle is recognized in this region of the charging station 1.

Alternatively or additionally, the charging station 1 draws attention by changing the brightness of the lighting device 11 or of the display device 7 and/or it guides a potential closer towards it, and/or it contributes to a brighter surrounding area illumination and thus a safer surrounding area, when it is recognized that a motor vehicle approaches the charging station 1 or when a ready-to-charge behavior of a passenger of a motor vehicle is recognized in the region of the charging station 1.

A climate control parameter of the charging station 1, in particular a temperature to which the temperature of the charging station 1 is controlled, or a climate control power is in particular selected as a function of a vehicle characteristic, in particular a vehicle type or vehicle model of a motor vehicle approaching the charging station 1, in particular as a function of an expected or maximum charging power of the vehicle.

On the basis of a specific vehicle characteristic, for example of a license plate of a motor vehicle approaching the charging station 1, it can in particular be verified whether the approaching motor vehicle corresponds to a motor vehicle, from which a charging request had previously been sent to the charging station 1—in particular via a data network. The charging station 1 can then in particular block the charging process for other motor vehicles and can release it only for that motor vehicle, for which the charging request had been received previously. Advantageously, a reservation of the charging station 1 is already possible in this way on the way to the charging station 1.

The content displayed on the display device 7 is in particular adapted to at least one characteristic of a passenger of a motor vehicle in the region of the charging station 1, or to a number or type of passengers of a motor vehicle in the region of the charging station 1.

The charging station 1 in particular communicates with at least one other charging station in order to negotiate which of the charging stations is more suitable for charging the approaching motor vehicle. A conclusion can in particular be drawn to a capacity of a battery installed in the motor vehicle on the basis of the vehicle characteristic. Alternatively or additionally, a charging state of the battery of the motor vehicle is obtained from the at least one signal, and the more suitable charging station is negotiated as a function of the charging state.

Technical, police and/or medical assistance is in particular called by sending a message or a transmission signal as a function of the behavior of a person or of another living being staying in the region of the charging station 1. Alternatively or additionally, the charging station opens a communication channel—in particular to a technical service—when a need for this is recognized on the basis of the behavior of the persons or of another living being staying in the region of the charging station 1.

The charging station in particular modifies the type and/or frequency of a content displayed on a display device 7 of the charging station 1 as a function of the number of persons staying in the region of the charging station 1 and/or of a frequenting of the region of the charging station 1 by persons or motor vehicles.

The charging station 1 in particular establishes a communication connection to a terminal of a user or to a communication module of a motor vehicle when correspondingly suitable encoded information, in particular a QR code is recognized.

In particular a receive signal or a message—in particular from a data network—is received by means of the communication module 3.2 as the at least one signal.

A message, with which a user sends a charging request to the charging station 1, is in particular received by the communication module. The receive signal or the message can in particular also comprise information about the charging state of a motor vehicle to be charged.

In addition, the at least one action is in particular initialized as a function of at least one surrounding area parameter of the charging station 1, in particular a location or a current time of day. Alternatively or additionally, a surrounding area temperature of the charging station 1 is used as the at least one surrounding area parameter.

An activity in the region of the charging station 1 is in particular recognized on the basis of camera images of the camera 3.1, and an activity-related message is sent as a function of the recognized activity and/or a communication channel is opened.

A communication channel is opened in order to provide technical aid, in particular in the form of a voice and/or video communication connection (video chat), in particular when an operating error or a technical problem in the operation of the charging station 1 is recognized as the activity.

A message is sent to an emergency response center or to an emergency service and help is called in particular, in particular when a health-related or medical problem of a person in the surrounding area of the charging station 1 is recognized as the activity.

A message is sent to a police station or a security service in particular when an unlawful or aggressive action against the charging station 1 itself or against persons in the surrounding area of the charging station 1, or a criminal offense, or vandalism, or the like is recognized as the activity. Alternatively or additionally, a message is displayed on the display device 7 of the charging station 1, by means of which persons in the surrounding area of the charging station 1 are informed that they are under surveillance, in particular are photographed or filmed. In addition, the recognized activity is preferably recorded permanently by means of the camera 3.1 in order to preserve evidence, for example stored digitally or in an analog manner, on a hard drive or another data storage and/or is transmitted, in particular via a data network, to the police station or the security service in order to preserve evidence.

Alternatively or additionally, encoded information is detected on the basis of the camera images of the camera 3.1, and a communication connection, in particular a streaming connection to the display device 7, is established as a function of the encoded information, so that visual contents, in particular movies, can be streamed on the display device 7, in particular the display 9.

1. A charging station for electrically powered motor vehicles, whereby the charging station is configured to detect at least one signal and to initialize at least one action as a function of the at least one detected signal.

2. The charging station according to claim 1, whereby the charging station has at least one detection device, which is configured to detect the at least one signal, whereby the at least one detection device is preferably selected from a group, consisting of: a communication module, in particular configured to communicate via a data network, and a camera.

3. The charging station according to claim 2, whereby the charging station has a control device, which is operatively connected to the at least one detection device and which is configured to initialize the at least one action as a function of the at least one signal detected by the detection device.

4. The charging station according to claim 2, whereby the at least one action is selected from a group, consisting of: Changing an operating state of the charging station, in particular switching over the charging station from a rest state into an active state, controlling the temperature of, in particular climate controlling, the charging station, setting a climate control parameter of the charging station, displaying a predetermined content on a display device of the charging station, sending a message or a transmission signal, activating a lighting device of the charging station, changing a brightness of a lighting device or of a display device of the charging station, modifying the type and/or frequency of a content displayed on a display device of the charging station, communicating with at least one other charging station, opening a communication channel, and establishing a communication connection.

5. The charging station according to claim 2, whereby the at least one detection device is formed as camera, and whereby the charging station is configured to inspect images recorded by the camera with regard to at least one inspection feature and to initialize the at least one action as a function of the at least one inspection feature, whereby in particular the at least one inspection feature is selected from a group, consisting of: A motor vehicle approaching the charging station, a ready-to-charge behavior of a passenger of a motor vehicle in the region of the charging station, a vehicle characteristic, in particular a vehicle type or vehicle model of a motor vehicle approaching the charging station, a license plate of a motor vehicle approaching the charging station, at least one characteristic of a passenger of a motor vehicle in the region of the charging station, a number or type of passengers of a motor vehicle in the region of the charging station, a behavior of a person or of another living being staying in the region of the charging station, a number of persons staying in the region of the charging station, a frequenting of the region of the charging station by persons or motor vehicles, and an encoded information, in particular a QR code.

6. The charging station according to claim 2, whereby the at least one detection device is formed as communication module, which is configured to receive a receive signal or a message, in particular from a data network, as the at least one signal.

7. The charging station according to claim 1, whereby the charging station is configured to additionally initialize the at least one action as a function of at least one surrounding area parameter of the charging station, whereby the at least one surrounding area parameter is in particular selected from a group, consisting of: A location of the charging station and a current time of day.

8. The charging station according to claim 2, whereby the charging station is configured to verify whether a motor vehicle approaches the charging station on the basis of camera images from the detection device, which is formed as camera, and to precondition the charging station when a motor vehicle approaches the charging station.

9. The charging station according to claim 2, whereby the charging station is configured to recognize an activity in the region of the charging station on the basis of camera images of the detection device, which is formed as camera, and to send out an activity-related message and/or to open a communication channel as a function of the recognized activity.

10. The charging station according to claim 2, whereby the charging station is configured to detect encoded information on the basis of camera images of the detection device, which is formed as camera, and to establish a communication connection as a function of the encoded information.

11. A method for operating a charging station, in particular according to claim 1, whereby at least one signal is detected by the charging station, in particular automatically, and at least one action is initialized by the charging station as a function of the detected at least one signal.
